(19) United States
(12) Patent Application Publication
(10) Pub. No.: US 2009/0283197 A1
(43) Pub. Date: Nov. 19, 2009

(54) Magnetically attractable fastening device

(76) Inventor: Ilya Gorodisher, Stillwater, MN (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 12/152,569

(22) Filed: May 15, 2008

(51) Int. Cl. B32B 37/00; B32B 3/06

(52) U.S. Cl. 156/60; 428/99; 428/35.7

(57) ABSTRACT

The present invention provides a magnetically attractable fastening device. The device comprises magnetically attractable ends joined together by a flexible bridge. The magnetically attractable ends each comprise at least one magnetically attractable element. At least one of the elements is a permanent magnet. The magnetically attractable elements are positioned in the ends of the device to provide a differential magnetic field at each end. The magnetically responsive elements are encapsulated in a non-magnetic material. The bridge that joins the ends of the device also comprise a non-magnetic material.

### FIELD

This invention relates to magnetic fastening devices and methods of using them.

### BACKGROUND

Magnetic closure devices are known and have been used in a variety of ways. For example, magnetic closure devices have been used to clasp or latch for jewelry, handbags, wallets, and money clips, etc. They have also been used as buttons, belt closures, zippers, nametag holders, and the like. Still further, they have been used to join paired garments together to prevent their separation during laundering and/or storage.

Magnetic closure devices have been provided in many forms. In one approach, one or more magnetic components have been permanently attached to an item to be joined or closed. This requires the physical alteration of the item so as to accommodate the magnetic component(s). As a result, the cost and complexity of manufacturing the item is increased. Additionally, if the item is a garment, the shape of the garment usually must be altered to accommodate the magnetic component. This often results in the formation of a lump in the garment, which can be both aesthetically unpleasing and cause discomfort to the wearer.

Furthermore, the permanent attachment of a magnetic closure device to an item often makes it more cumbersome to use. For example, when a permanently attached magnetic closure device is used to join garments, the separate garments must be individually snapped or otherwise joined together. Moreover, the very nature of permanent attachment renders such magnetic fasteners non-interchangeable or permanently dedicated to a specific garment. Additionally, when these joined garments are laundered, they often become magnetically attached to the drum of the washer and/or dryer. This makes them more difficult to remove from the washer and/or dryer and can limit the washing and/or drying efficiency because of a lack of unrestricted agitation and/or tumbling.

Another approach is disclosed in U.S. Pat. No. 5,682,653. In this approach a magnetically responsive element is held in opposite ends of a shrink-wrapped tube. At least one of the magnetically responsive elements comprises permanent magnet and a backing plate of a magnetically soft material. Magnetically soft materials have a high magnetic permeability. As a result, the backing plate increases the size of the magnetic field of the device and renders it unsatisfactory for many uses. Additionally, the shrink-wrapped tube of this patent is left open to the environment as shown if FIG. 2 of this patent. As a result, this approach suffers from the disadvantage that it has essentially no resistance to the effects of ambient conditions such as moisture.

### SUMMARY

The present invention overcomes these, and other, disadvantages of the prior art.

In one embodiment, the present invention provides a magnetically attractable fastening device comprising first and second magnetically attractable ends, each end having opposed surfaces, and a non-magnetic flexible bridge connecting the first and second ends, wherein
(a) each of the first and second ends comprises a magnetically responsive material encapsulated, preferably hermetically encapsulated, by a non-magnetic material;
(b) the magnetically responsive material of at least one of the first and second ends comprises at least one magnet;
(c) the magnetically responsive material of the other of the first and second ends comprises at least one magnet or at least one magnetizable element; and the first and second ends have a differential magnetic field.

In another embodiment, the present invention provides a magnetically attractable fastening device comprising a first magnetically attractable end attached to a second magnetically attractable end by a non-magnetic bridge, wherein

each of the first and second ends comprises opposed surfaces and at least one magnetically responsive element encapsulated within a non-magnetic polymeric material, and

at least one magnetically responsive element of each of the first and second ends is closer to one of the opposed surfaces of each of the first and second ends than it is to the other of the opposed surfaces of the first and second ends to provide a differential magnetic field around each of the first and second ends.

In yet another embodiment, the present invention provides a magnetically attractable fastening device comprising two magnetically attractable ends joined to one another by a non-magnetic bridge, each of the magnetically attractable ends comprising (i) a non-magnetic outer skin having first and second opposed surfaces, (ii) at least one magnetically responsive element between the opposed surfaces of each end, and (iii) a non-magnetic spacer between the magnetically responsive element and one of the opposed surfaces of the non-magnetic outer skin, wherein at least one of the magnetically responsive elements comprises a magnet.

As used herein, “encapsulated” means that the magnetically responsive elements are surrounded on all sides by another material or other materials.

As used herein, the phrase “hermetically encapsulated” means that the magnetically responsive elements of the closure device are entirely surrounded by a material that renders them impervious to corrosion from ambient moisture. Preferably the material encapsulates the magnetically responsive elements so that they are essentially immovable within the body.

As used herein, “non-magnetic material” means a material that does not respond to a magnetic field. They are characterized as having a low magnetic permeability. That is, such materials are essentially unaffected by magnetic fields.

As used herein, “differential magnetic field” means that the strength of the magnetic field is stronger on through one surface of the magnetically responsive end than it is through an opposed surface of the magnetically responsive end.

The magnetically responsive elements used in the present invention are preferably eccentrically positioned within the magnetically responsive ends. That is, each magnetically responsive element is closer to one of the surfaces of each of the ends than it is to the other of the surfaces of each of the ends. Additionally, each magnetically responsive element is preferably immovably held within each end of the device.

The closure device of the present invention has numerous advantages not previously provided. For example, the device of the invention is a one-piece, stand-alone, reusable device. Consequently, the item or items to be closed do not need to be altered in any way in order for the device to be used. Additionally, the device of the invention can be used to close an open container, such as an open food bag, to retain the freshness of the contents of the bag. Alternatively, it may also be used to join paired clothing items for washing, drying, and storage. They can be used to instantly convert any board into a clipboard. The device is capable of holding down sheets of paper and related to said board by clasping the sheets and board between its magnetic ends.

The device can further be employed to hang sheet-like objects without damaging them. In particular several magnetic devices described herein are useful for hanging curtains, valences, and drapes as well as shower curtains without the need to perforate holes in said drapes or curtains as would be necessary using the conventional hangers.

Furthermore, because the magnetically attractable elements of the device are encapsulated in a non-magnetic material, they are less susceptible to corrosion from moisture. As a result, the device of the invention prevents corrosion products, e.g., rust, from transferring to, for example, paired garments. This is of particular importance when the closure device is used with paired-garments during laundering.

Still further, the preferable eccentric positioning of the magnetically attractable elements provides a differential magnetic field that enables preferential magnetic attraction between the magnets. This allows the device to firmly grasp an item between the magnetically attractable elements with a force sufficient to resist premature opening of the device. This is of particular value during laundering and drying operations.

### BRIEF DESCRIPTION OF THE DRAWINGS

The accompanying drawings depict one embodiment of the present invention. This embodiment is representative of the various embodiments of the invention as will be understood by those skilled in the art. In these figures, like reference numbers refer to the same elements throughout the various views. In these drawings:

FIG. 1 is a schematic plan view of an embodiment of a magnetically attractable fastening device according to the invention;

FIG. 2 is an edge view of the magnetically attractable fastening device of FIG. 1;

FIG. 3 is a cross-sectional view of the magnetically attractable fastening device of FIG. 1 taken along line 3-3 in FIG. 1;

FIG. 4 is a plan view of another embodiment of a magnetically attractable fastening device according to the invention.

FIG. 5 is a cross-sectional view of the magnetically attractable fastening device of FIG. 4 taken along line 5-5 of FIG. 4;

FIG. 6 is a cross-sectional view of one end of yet another embodiment of the magnetically attractable fastening device of the invention;

FIG. 7 is an illustration of the device of the invention being used to close an open bag.

### DETAILED DESCRIPTION

The present invention will be further discussed with respect to the illustrative embodiments shown in the several Figures.

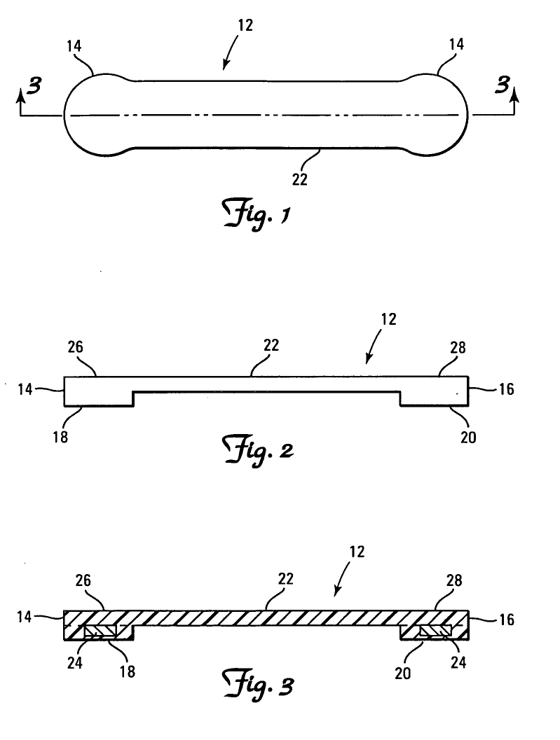

Referring now specifically to FIGS. 1-3, one embodiment of the magnetic fastening device of the invention is shown that comprises a non-magnetic outer body 12. Body 12 has first and second magnetically attractable ends 14 and 16 respectively. Each end 14 and 16 has opposed surfaces 18, 20, 26, and 28. A flexible bridge 22 connects the first and second magnetically attractable ends 14 and 16.

Each of the magnetically attractable ends comprises a magnetically responsive element 24 and outer body 12. Preferably, the elements 24 are hermetically encapsulated within the body. Each element 24 is eccentrically positioned within each end 14 and 16. Preferably, the magnetically responsive elements 24 are immovable within ends 14 and 16.

Flexible bridge 22 may be of any length and shape. For example, it may be relatively wide as illustrated in the FIGS. Alternatively, it may comprise one or more individual strands of material. Additionally, the length of bridge 22 may be short or long depending upon the intended use of the device. For example, a shorter bridge 22 may be preferred where a thin item is to be held by the device, while a longer bridge may be preferred where a thicker item is to be held by the device.

With reference now specifically to FIG. 3, each of the magnetically responsive elements 24 is closer to surfaces 18 and 20 than they are to surfaces 26 and 28. This preferably creates a stronger magnetic filed through surfaces 18 and 20 than through surfaces 26 and 28 and results in a preferential attraction between surfaces 18 and 20. Magnetically attractable elements 24 are encapsulated in body 12 in a manner that when surfaces 18 and 20 are brought into face-to-face proximity, the N pole of one of magnet 18 faces the S pole of the other magnet 18.

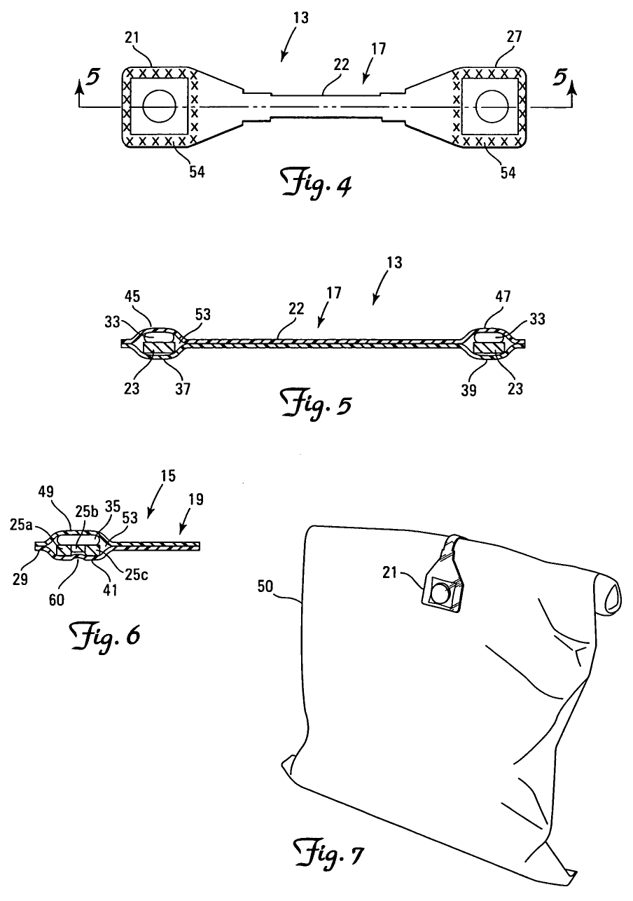

FIGS. 1-3 illustrate an embodiment of the invention in which a difference in the thickness of the non-magnetic material of body 12 provides the eccentric positioning of the magnetically responsive elements 24 in ends 14 and 16. FIGS. 4-6 illustrate another way by which eccentric positioning may be achieved.

In the embodiments of FIGS. 4-6, fastening devices 13, 15 comprise non-magnetic outer body 17, 19 and magnetically attractable ends 21, 27, 29. The ends 21, 27, 29 comprise a magnetically responsive element or elements 23, 25 and a spacer 33, 35. Spacer 33, 35 comprise non a non-magnetic material. Spacer 33, 35 positions magnetically responsive elements 23, 25 such that they are closer to surfaces 37, 39, 41 than they are to surfaces 45, 47, 49. That is, the spacers eccentrically position magnetically attractable elements 23, 25a, b, c within ends 21, 27, 29.

The embodiments of FIGS. 4-6 provide examples of other possible variations of the invention. For example, the magnetically responsive elements do not have to be in total contact with the non-magnetic outer body as shown in FIGS. 1-3. Rather, they may have only minimal contact with the outer body as shown in FIGS. 4-6. FIGS. 4-6 show that there may be void spaces 53 around the magnetic elements. FIG. 4 also shows that the magnetically responsive elements are encapsulated at seam 54 by body 17.

Additionally, FIG. 6 shows a device of the invention that employs more than one magnetically responsive element in each magnetically attractable end. Thus, the magnetically attractable end may comprise two (not shown), three (shown) or more such elements.

The embodiment of FIG. 6 illustrates the use of three magnetically responsive elements 25a, 25b, 25c in the attractable end 29. As shown, element 25b is between elements 25a and 25c and is thinner than elements 25a and 25b. As a result, the three elements present an irregular surface that provides a contoured surface 60 in the region of the magnetically attractable end 29 of body 19. See FIG. 6.

When two contoured surfaces 60 of the magnetically attractable ends are contacted to each other, the topography of contoured surfaces 60 provides added gripping strength. As a result, an item between the two surfaces 60 is held more firmly than if there were no discontinuities.

It will be understood that FIGS. 4-6 represents only one topography of contoured surface 60. Other topographies are also useful as will be understood by one of skill in the art. Such other topographies may include a male/female interconnecting relationship. It will be further understood that the topography of contoured surface 60 may be provided without any contribution from the magnetically responsive elements. Thus, molding, embossing, abrading, ablating, chemical etching, etc may create the topography of surface 60.

The figures illustrate an elongated magnetic fastening device. The device may have an elongate dumbbell shape as shown. Alternatively, it may have a rectangular shape, an oval shape, a circular shape, etc. Other shapes are also useful as will be understood by those of skill in the art based upon reading this disclosure.

The material used in the body of the device may be selected from any of a variety of materials. Preferably, these materials have a low magnetic permeability. Low magnetic permeability materials are preferred because they minimize the size of the magnetic field around the devices. The size of a given field can be adjusted by the thickness of the low permeability material around the magnetically responsive elements.

It is also preferred that the body material are impervious to moisture, that is, they do not absorb moisture. It is also preferred that the body material does not degrade in the presence of moisture. Additionally, it is preferred that the body material be resistant to temperatures encountered during the laundering process (washing and drying). These temperatures generally are in the range of from about room 5 to about 90oC, preferable from room temperature (e.g., 20° C. to 80° C.) for washing and from about 30 to about 80oC for drying. Additionally, it is preferred that the body material be readily processed at temperatures in the range of from about 50 to about 80oC.

Materials useful as the body include polymeric materials. Examples of useful polymeric materials include thermoplastic and thermosetting polymers. Examples of useful thermoplastic polymers include, but are not limited to addition polymerized polymers and copolymers. These include polymers and various copolymers of poly(meth)acrylates, polyolefins including polyvinylchloride, plasticized polyvinylchloride, polystyrene, polyisoprene, polytetrafluoroethylene, polyvinylidene fluoride and their perfluorinated and partially fluorinated copolymers with, for example, fluorinated vinyl ethers and acetates (including ethylene vinyl acetate).

Useful thermoplastic polymers also include condensation polymerized polymers such as polyamides, polyesters, polyurethanes, polyimides. Still other useful thermoplastic polymers include polyethers (e.g., polypropylene glycol, polyethylene glycol), polyureas and polycarbonate.

Examples of useful thermosetting polymers include epoxides, especially toughened epoxides, crosslinked elastomers (e.g., crosslinked urethanes, crosslinked siloxanes (silicones), crosslinked fluoroelastomers, and crosslinked diene rubbers.

The material used as the spacer preferably has a low magnetic permeability and is not susceptible to degradation in water. It may be selected from the same materials used as the body. Additionally, it may comprise a foamed material such as a foamed pressure sensitive adhesive tape.

The device of the invention includes two magnetically attractable elements, at least one of which comprises a permanent magnet. The other magnetically attractable element may be selected from a material that can be magnetized when brought into proximity to the magnet. Examples of such materials include magnetically soft materials such as iron and nickel. Alternatively, and preferably, the other magnetically attractable element may comprise another permanent magnet.

Permanent magnets useful in the present invention include rare earth magnets, ferrite magnets and alnico magnets. The magnetic field typically produced by rare-earth magnets can be in excess of 1.2 teslas. Ferrite or ceramic magnets typically exhibit fields of 50 to 100 milliteslas.

Rare earth magnets, which are typically made from alloys of rare earth metals, are preferred because of their substantially greater magnetic field. Examples of rare earth magnets useful in the invention include alloys of neodymium and samarium. Neodymium magnets are made of neodymium, iron and boron. Samarium magnets are typically composed of samarium and cobalt. Samarium Cobalt magnets are available in two “series”, namely Series 1:5 and Series 2:17. Samarium-cobalt magnets have a relatively high Curie point, which makes them suitable for high-temperature environments.

When joined together without any intervening material (e.g., garment or body material), the magnetically responsive elements typically have a holding power, as measured by the forces required to separate the elements, of from about 1 to 40 lbs. (about 0.4 to 20 kg) of force. Preferably the magnetically responsive elements have a holding power of at least 4 lbs. (about 2 kg).

FIG. 7 shows one example of the device of the invention in use. An item to be held, here a bag 50, is placed between the opposite ends 21, 27 of the device. The ends are then brought together so that the N pole of one end is attracted to the S pole of the other end. When it is desired to remove the item from the device of the invention, the user simply grasps the two opposing ends and separates them from one another.

As noted above, the device of the invention is useful for holding paired garments during laundering (i.e., washing and drying). During the washing and drying process, the tumbling action of the washer and/or dryer typically provides sufficient mechanical action to prevent the closure device from becoming continuously att6ached to the metal drum of the machine. This provides for a more efficient laundering process. Furthermore, the preferential magnetic attraction of the device to itself, even with a paired item between the opposing ends, is sufficient to overcome those forces trying to open the device during normal laundering operations.

Once laundering has been completed, the paired garments may become attached to the drum of the washer and/or dryer. The garments may be readily retrieved from the particular machine by physically grasping the garments and removing them by hand. Alternatively, they may be more easily removed by employing a magnetic retrieval wand. Such a wand comprises an elongate shaft that incorporates a permanent magnet or magnets whose magnetic strength is strong enough to attract the paired garments with more force than the magnetic force, if any, holding the to the drum of the machine. Once the desired number of garments has become attached to the wand, the user simply removes it from the machine.

The closure device of the present invention may be manufactured in a variety of ways. In one embodiment, a first sheet of body 12 material is provided. Cavities are provided in the sheet that are large enough to receive the magnetically responsive elements 24 at opposite ends of the sheet. The magnetically responsive elements are then placed in the cavities and a second sheet 12 of material is then provided and placed over the first sheet so as to cover the cavities and encapsulate the magnetically responsive elements. The two sheets are then secured to one another so as to provide a hermetic seal around the magnetically responsive elements.

In another embodiment, a length of a first sheet of body material 17, 19 is provided. The magnetically responsive elements 23, 25a-c are then placed on the body material near each end. The magnetically responsive elements are positioned near the ends so that the body material extends beyond them. Any desired spacer material 33, 35 is then placed over the magnetically responsive elements. A length of a second sheet of body material 17, 19 is then placed over the combination of the first sheet, the magnetically responsive elements, and the spacers. The second sheet of body material is then secured to the first sheet at seam 54 so that the magnetically responsive elements are sealed around their periphery between the two sheets. If the two sheets differ significantly in thickness, the use of the spacer material may not be necessary to provide the differential magnetic field.

Various techniques may be used to seal the body materials around the magnetically responsive elements. These include adhesive bonding, thermal welding, radio frequency welding, solvent welding, etc.

In still another embodiment, the body of the device of the invention may be thermoformed around the magnetically attractable elements using techniques know in the art. Examples of techniques include laminating, press molding, extrusion molding, injection molding, etc.

Other embodiments of the present invention will be apparent to those skilled in the art upon consideration of this specification or from practice of the invention disclosed herein. Various omissions, modifications, and changes to the principles and embodiments described herein may be made by one skilled in the art without departing from the true scope and spirit of the invention which is indicated by the following claims.

1. A magnetically attractable fastening device comprising first and second magnetically attractable ends, each having opposed surfaces, and a non-magnetic flexible bridge connecting the first and second ends, wherein
each of the first and second ends comprises a magnetically responsive material hermetically encapsulated within a non-magnetic material;
the magnetically responsive material of at least one of the first and second ends comprises at least one magnet;
the magnetically responsive material of the other of the first and second ends comprises at least one magnet or at least one magnetizable element;
the first and second ends have a differential magnetic field.

2. The fastening device of claim 1, wherein the non-magnetic material encapsulating the magnetically responsive material comprises a polymeric material.

3. The fastening device of claim 2, wherein the polymeric material is a thermoplastic polymer.

4. The fastening device of claim 3, wherein the thermoplastic polymer is selected from the group of addition-polymerized polymers or copolymers, and condensation-polymerized polymers.

5. The fastening device of claim 2, herein the polymeric material is a thermoset polymer.

6. The fastening device of claim 1, wherein each of the first and second ends comprises a permanent magnet.

7. The fastening device of claim 1, wherein the first and second magnetically attractable ends each have opposed first and second surfaces, and wherein the magnetically responsive material of each of the first and second ends is closer to the first surface of each end that it is to the second surface of each end.

8. The fastening device of claim 7 further comprising a non-magnetic spacer between magnetically responsive element and the second surface of each end.

9. The fastening device of claim 7, wherein the permanent magnet comprises a rare earth magnet.

10. A magnetically attractable fastening device comprising a first magnetically attractable end attached to a second magnetically attractable end by a non-magnetic bridge, wherein
each of the first and second ends comprises opposed surfaces and at least one magnetically responsive element encapsulated within a non-magnetic polymeric material,
the at least one magnetically responsive element of each of the first and second ends is closer to one of the opposed parallel surfaces than it is to the other of the opposed surfaces of the first and second ends to provide a differential magnetic field around each of the first and second ends.

11. A magnetically attractable fastening device comprising two magnetically attractable ends joined to one another by a non-magnetic bridge, each of the magnetically attractable ends comprising (i) a non-magnetic outer skin having first and second opposed surfaces, (ii) at least one magnetically responsive element between the opposed surfaces of each end, and (iii) a non-magnetic spacer between the magnetically responsive element and one of the opposed surfaces of the non-magnetic outer skin, wherein at least one of the magnetically responsive elements comprises a magnet.

12. An assembly comprising the fastening device of claim 1 and an item held between the magnetically attractable ends.

13. The assembly of claim 12 wherein the item comprises a garment held between the magnetically attractable ends.

14. The assembly of claim 12, wherein the item comprises a flexible container held between the magnetically attractable ends.

15. The assembly of claim 12, wherein the item comprises a sheet-like object.

16. A method of securing an item comprising the steps of:
a) providing the fastening device of claim 1;
b) providing a garment to be secured;
c) placing the garment between the magnetically attractable ends; and
d) contacting the magnetically attractable ends to each other with the garment therebetween.

17. The method of claim 16 comprising the further step of laundering the garment.

18. The method of claim 17 comprising the further step of drying the garment.

19. The method of claim 18, wherein the garment comprises a paired garment.

20. The method of claim 18 comprising the further step of magnetically retrieving the garment.
